(19) United States
(12) Patent Application Publication
(10) Pub. No.: US 2015/0319518 A1
(43) Pub. Date: Nov. 5, 2015

(54) System and Apparatus for Delivering Selectable Audio Content

(71) Applicant: Kevin Wilson, Agoura Hills, CA (US)

(72) Inventor: Kevin Wilson, Agoura Hills, CA (US)

(21) Appl. No.: 14/269,199

(22) Filed: May 4, 2014

(51) Int. Cl. H04R 1/10; H04R 3/00

(52) U.S. Cl. CPC H04R 1/10; H04R 3/002; H04R 2499/15; H04R 2420/07

(57) ABSTRACT

A system and method are disclosed for a viewer to dynamically select a dialogue track corresponding to a video. Audio channels are synced with the video and transmitted to the viewer's listening device. The user is able to dynamically switch between the audio channels, which may correspond to dialogue in various languages or dialects. Noise cancellation signals are used to improve the viewer's experience. Viewers can adjust the volume of the audio channel and the noise cancellation. A viewer's usage of the disclosed features is optionally monitored and analyzed.

### TECHNICAL FIELD

This disclosure relates to the field of communications, specifically user-selectable audio content.

### BACKGROUND OF THE INVENTION

Movie theaters attract large numbers of viewers and play a significant role in the worldwide multi-billion dollar motion picture industry. In the United States, a majority of movies played in theaters are in the English language. A limited number of theaters offer movies with audio or subtitles in other languages. Thus, there is a demand for a movie-going experience available to non-English speaking patrons.

The transition to digital technology has created an opportunity to reach a wider audience than before. Various market research reports have concluded that there is a large and growing demand for dubbed and subtitled films, particularly in the Hispanic community. Although the growing Latino population comprises roughly 15% of the U.S. population, this population represents roughly 28% of movie audiences. While Spanish speaking persons may attend English only films, research indicates that only about 18% of English speaking Hispanics have accompanied their Spanish speaking family members to subtitled films. Due to the limited number of theaters that show movies in non-English languages, many Spanish speaking persons are discouraged from watching movies in theaters. Other communities of non-English speakers are similarly discouraged from watching movies in theaters because they are unable to understand the English dialogue. The same may apply to any person who does not speak the native language of the community or country in which the person is located, such as an English-speaking viewer in a theater in China.

The transition of the movie industry to digital technology and the worldwide releases of feature films has led to the production of multiple language tracks while a movie is in theaters. However, few theaters have taken advantage of the readily available multiple language tracks.

Another audience discouraged from watching movies in theaters includes individuals that are deaf or experience hearing loss that makes it difficult to understand dialogue over ambient sounds and noises. According to a 2010 report, the National Institute of Deafness and Other Communication Disorders, a part of the National Institutes of Health, estimated that approximately 17% of American adults report some degree of hearing loss. Further, according to the World Health Organization, over 360 million people worldwide have disabling hearing loss. People that are deaf or experience hearing loss must either wait for the movie to be released on home video with a subtitle track, or go to particular show times when a subtitled movie is being aired. However, few theaters offer this feature, and the limited show times may be inconvenient for viewers.

Even if a person can understand the English dialogue, they may not be able to understand the dialogue because the volume level is low, or the volume level of a theater is so high that it is uncomfortable for them to listen. The movie industry standard volume is volume level 7, which is equal to 85 decibels. With the transition to digital technology, the audio tracks for movies can be readily mixed to higher volume levels than the industry standard. Some action movies have sustained levels of 90 decibels with peaks between 120-130 decibels. Even some children's movies have been found to be as loud as action movies. On the other end of the spectrum, documentaries are the quietist. Even for an English speaking patron, the wide range of volumes in a theater can be problematic and interfere with the enjoyment of the movie.

According to the Centers for Disease Control and Prevention, an estimated 12.5% of children and adolescents aged 6-19 and 17% of adults aged 20-69 have suffered noise-induced hearing loss from excessive exposure to noise. Noise induced hearing loss can result from a single exposure to a loud sound or from listening to loud sounds over an extended period of time. For children and adolescents, a small amount of hearing loss can have a profound negative impact on speech, language comprehension, communication, classroom learning and social development without proper intervention. In response, some movie theaters have turned down the volume. As a result, the dialogue track is also lowered, making it difficult to hear for some viewers.

Various systems have been designed to expand the availability of movies to non-native speakers and persons that are deaf or experience hearing loss. For example, Newman EP 1,185,138, entitled “System for delivering audio content” discloses a headphone speaker system for use in motion picture theaters for hearing impaired viewers and viewers that do not speak the spoken language of the original movie. The system comprises headphones with a control for selecting the language and adjusting the volume, and a central router/processor that is connected to the film source. The central router/processor transmits the various audio tracks (mono or stereo) to the headphone via wired or wireless means. However, the Newman system does not disclose a method or apparatus to reduce the ambient sounds and noises, including the dialogue track, played through the theater speakers. As a result, the user of the Newman system is required to increase the volume of the headphones, which can be uncomfortable or damaging to the user's hearing, especially considering the extended period of time the user is wearing the headphones.

In 2012, Sony Corporation began providing a system to movie theaters that displayed closed captions to visually impaired persons. The system includes a Digital Cinema Projector, Digital Cinema Server, data transmitter, and a portable receiver box. Glasses and/or headphones are connected to the portable receiver box. The transmitter transits closed caption data to the receiver, which is then displayed on the user's glasses. In addition, the transmitter can transmit audio data to the receiver, which is then played through the user's headphones. The Sony system discloses support for Hi audio (assistive audio) and VI-N audio (audio description). One disadvantage of the Sony system is that it relies on the use of third party headphones, which may not effectively cancel ambient sounds in the theater.

Some software solutions have been developed to allow a movie viewer to listen to a different language track using the viewer's smart phone. The user first purchases and downloads a desired audio track to the smart phone. After any movie trailers, but before the movie begins, the user initializes the software solution to synchronize its audio output with the video displayed on the screen. The software can use the microphone of the smart phone to sample the audio from the theater speakers to determine the timing position. Thereafter, the software plays an audio track in a different language through the user's headphones while the user watches the movie in the theater. One disadvantage of this system is that the user must select and load the desired audio track(s) before going to the movie theater. If the desired show time is sold out, the user may try to download an audio track for another movie, or the user may decide not to watch a movie at all. If a viewer is required to provide their own headphones, the headphones may be insufficient to block out ambient sound in the theater. In addition, a smart phone-based application requires the viewer to use a smart phone in the theater at the risk of disturbing other patrons. Further, running an application on a smart phone for the duration of a movie may significantly drain the phone's battery.

Because the audio and video of digital movies are typically encrypted, the distributor must provide unencrypted audio tracks for a third party software developer to produce an audio track. Unencrypted audio tracks are susceptible to piracy or manipulation, providing a disincentive for content providers to make such tracks available to the public. As a result, third party software solutions are currently available for only a limited number of movie titles.

Although the systems and methods described above purport to allow a viewer to listen to different tracks, the viewer's movie-going experience will suffer if the audio is not properly synced to the images. This effect is particularly pronounced when the audible dialogue does not correspond to the movement of the speaker's mouth. Thus, a need exists for a system and method that effectively sync a language track to the mouth movement of the speaker.

Methods have been developed to enable multiple viewers to watch different images on the same screen. For example, Ko U.S. Patent Publication No. 2010/0177174, entitled “3D Shutter Glasses with Mode Switching Based on Orientation to Display Device,” discloses a “screen sharing” system in which two or more viewers can each be provided with different images on one display. Screen sharing glasses would allow a viewer to not only select the language track for the desired movie, but also decide to watch a dubbed version of the movie synced to the audio track.

In view of the foregoing, there is a need for a system that allows multiple users to watch the same video while individually adjusting the audio track.

In addition, a need exists for a system that allows a viewer to cancel out ambient sounds and noises.

A further need exists for a system that allows a user to automatically sync an audio track with the display on the screen.

Another need exists for an ability to monitor actual use of an audio track and aggregate usage data for multiple viewers.

A need exists for an ability to dynamically adjust the volume level of an audio track.

Yet another need exists for a system that allows an operator to provide equipment for viewers to automatically sync audio tracks with the display on the screen, thereby allowing the operator to provide a consistent experience to all viewers.

A further need exists for a system that allows multiple viewers to listen to different dubbed versions of a video displayed on a single screen.

### SUMMARY OF THE INVENTION

The present disclosure provides a system, method, and apparatus for providing user-selectable audio tracks that are synced with a video display. In the preferred embodiment, the system comprises a video projector, a plurality of listening devices, a selectable audio provider, and a plurality of speakers. Users wearing the listening devices are able to dynamically configure the audio track and volume levels they experience. The selectable audio provider transmits a plurality of audio tracks synced to the video for the users to select on their listening device. For example, a viewer may select a dubbed audio track featuring translated dialogue in a familiar language. A user can further customize their experience by enabling noise cancellation on the listening device to lower the ambient sounds. Each listening device collects usage information, including for example, the volume level, noise cancellation level, and audio track selected. The listening devices' usage data can be transmitted to the selectable audio provider, which can adjust the overall system level, noise cancellation level, and audio tracks to transmit.

### BRIEF DESCRIPTION OF THE DRAWINGS

The detailed description makes reference to the accompanying figures wherein:

FIG. 1A illustrates an exemplary system diagram according to the preferred embodiment of the present invention.

FIG. 1B is a block diagram of an exemplary selectable audio provider.

FIG. 2A illustrates an exemplary system diagram of an embodiment of the present invention.

FIG. 2B illustrates an exemplary system diagram of an embodiment of the present invention.

FIG. 3A illustrates a listening device according to the preferred embodiment of the present invention.

FIG. 3B illustrates an exemplary circuit diagram of a headphone speaker of a listening device according to the preferred embodiment of the present invention.

FIG. 4 illustrates a listening device according to an embodiment of the present invention.

FIG. 5 is a flowchart depicting a process according to the preferred embodiment in the context of a movie theater showing.

Other objects, features, and characteristics of the present invention, as well as methods of operation and functions of the related elements of the structure and the combination of parts, will become more apparent upon consideration of the following detailed description with reference to the accompanying drawings, all of which form part of this specification.

### DETAILED DESCRIPTION OF THE PREFERRED EMBODIMENT

A detailed illustrative embodiment of the present invention is disclosed herein. However, techniques, methods, processes, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

None of the terms used herein are meant to limit the application of the invention. The terms are used to illustrate the preferred embodiment and are not intended to limit the scope of the invention. Any reference to a specific language is exemplary, as the present invention may be used with any variety of languages, dialects, accents, or other variations of audio communication. The invention is versatile and can be utilized in many applications, as will be apparent in light of the disclosure set forth herein. The following presents a detailed description of the preferred embodiment of the present invention with reference to the figures.

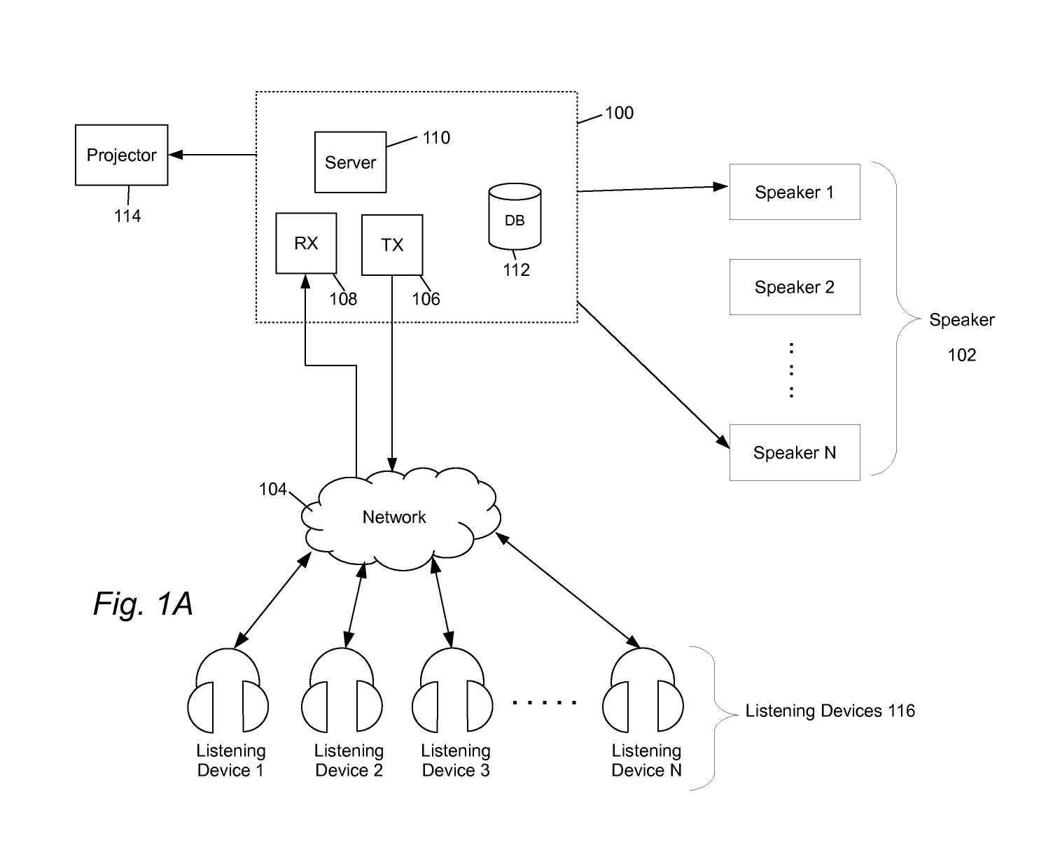

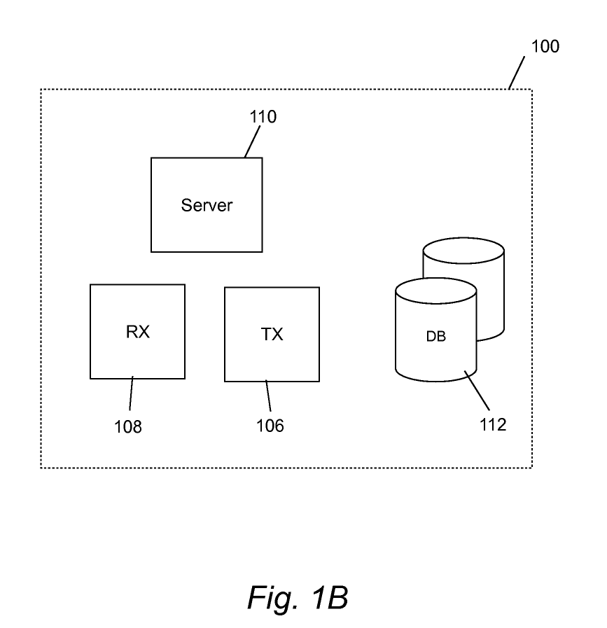

Referring initially to FIG. 1A, shown is an exemplary diagram for providing audio to a user wearing one of listening devices 116 in a movie theater. Listening devices 116 communicate over network 104 with selectable audio provider 100. Selectable audio provider 100 comprises transmitter 106 and receiver 108 for communicating to and/or from listening devices 116 through network 104. In the preferred embodiment, selectable audio provider 100 is coupled to digital movie projector 114, which projects video onto a traditional movie screen. It should be understood that, in some embodiments, selectable audio provider 100 may provide the video signal to digital movie projector 114, and in other embodiments, digital movie projector 114 may provide the audio channels to selectable audio provider 100. It should also be understood that, in some embodiments, selectable audio provider 100 may be integrated within digital movie projector 114.

Network 104 is preferably a wireless local area network (LAN) and permits the transfer of data to and/or from transmitter 106, receiver 108, and listening devices 116. The data transmitted through network 104 between transmitter 106, receiver 108, and listening devices 116 can be transmitted and/or received utilizing standard telecommunication protocols or standard networking protocols. In the preferred embodiment, network 104 utilizes Bluetooth or 2.5/5.0 GHz cordless phone frequencies.

In the preferred embodiment, server 110 synchronizes the video signal transmitted by digital movie projector 114 and the plurality of audio channel signals transmitted to listening devices 116 by transmitter 106. As a result, the users of listening devices 116 can each listen to a different audio track that is synchronized with the video displayed by digital movie projector 114.

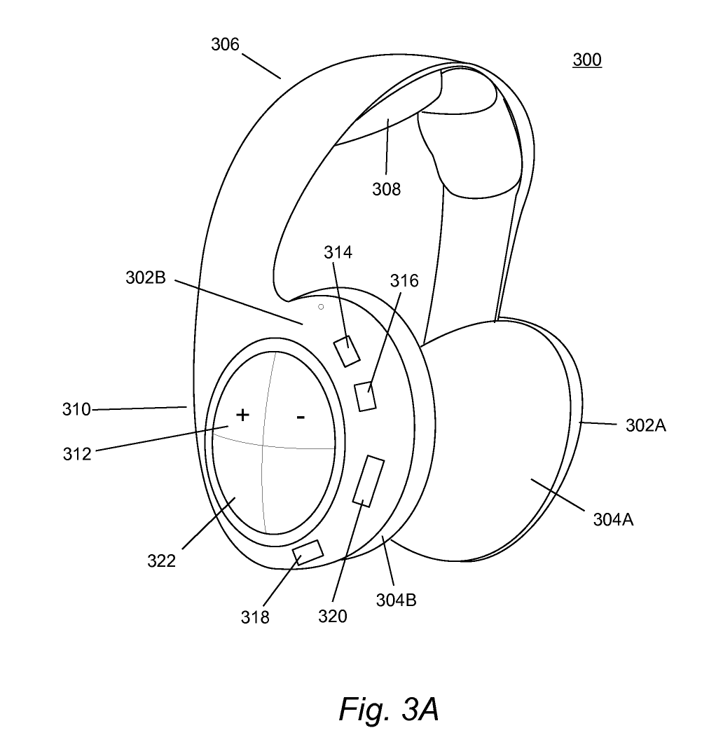

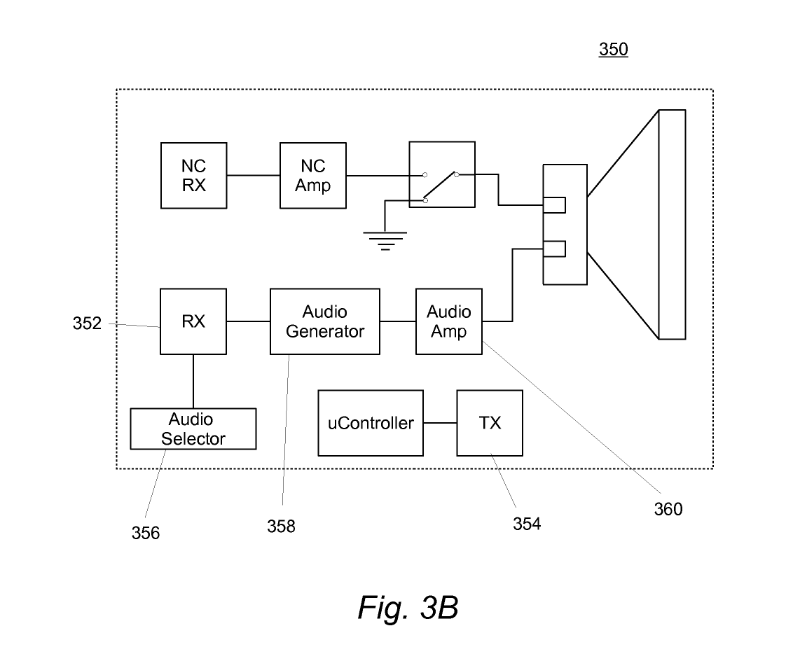

Selectable audio provider 100 also transmits audio to a plurality of speakers 102. In the preferred embodiment, the audio transmitted to speakers 102 includes the native dialogue track of the video displayed by digital movie projector 114. In this configuration, listeners who want to listen to the native dialogue track of the movie are not required to use listening devices 116. In other words, a viewer that is not using one of listening devices 116 will still experience the movie in the conventional manner. Users wearing listening devices 116 can enhance their experience by selecting a different audio track such as Spanish, German, French, Hindi or any other language transmitted by selectable audio provider 100. As described below and with reference to FIG. 3B, listening devices 116 include a noise canceling circuit to cancel the native dialogue track from speakers 112, thereby allowing users of listening devices 116 to primarily hear the dialogue track of their selected language. In one embodiment, the dialogue track is not played from speakers 102. In such an embodiment, all users are required to wear listening devices 116 to hear the dialogue track of their preferred language.

In some embodiments, directional microphones are positioned throughout the theater and directed to listen to noise from adjacent theaters. The noise recorded by the directional microphones are transmitted to selectable audio provider 100, which generates a noise-cancelling channel to transmit to listening devices 116. In some embodiments, selectable audio provider 100 stores the position of the directional microphones and the amplitude of the noise signals measured. The readings are periodically updated, thereby allowing selectable audio provider 100 to determine the location of the highest noise signal and automatically adjust the amplitude of the noise canceling signal transmitted to listening devices 116 in areas of the highest noise measurements. As a result, the sound bleed between adjacent movie theaters can be minimized. Accordingly, movie theaters with poor sound insulation do not need to lower the volume. In yet another embodiment, the directional microphones are directly coupled to a noise canceling generator that transmits a noise canceling signal to nearby listening devices 116.

Referring now to FIG. 1B, shown is a block diagram of an exemplary selectable audio provider 100. Selectable audio provider 100 comprises server 110, and database 112, which preferably comprises conventional random access memory. Database 112 stores data associated with usage of listening devices 116. Database 112 further stores audio tracks for transmission. Server 110 can accept a movie distributed through optical disks, hard drives, or the Internet. Server 110 is configured to decrypt the encrypted video and plurality of audio track of the loaded movie. In addition, server 110 synchronizes the audio tracks which are sent to transmitter 106 and speakers 102, and the video signal transmitted to projector 114. In the preferred embodiment, where speakers 102 play the desired dialogue track for the movie, selectable audio provider transmits a noise canceling channel that includes the native dialogue phase offset by 180 degrees. The noise canceling receivers of listening devices 116 receive and superimpose this noise canceling channel. As a result, users of listening devices 116 do not hear (or hear at a substantially reduced volume) the native dialogue track when the noise canceling circuits of listening devices 116 are enabled.

Selectable audio provider 100 further comprises receiver 108. Receiver 108 is configured to receive current usage data from listening devices 116. Long term usage data is stored in database 112 to determine frequently selected dialogue tracks, average volume levels, and average noise cancellation levels. This information is used by selectable audio provider 100 to automatically adjust settings, thereby reducing the amount of time required for users to configure listening devices 116.

In some embodiments, selectable audio provider 100 utilizes the usage data to dynamically determine an audio track that is not in use. In such embodiments, an operator of selectable audio provider 100 sets a threshold time period for an audio channel to not be in use by listening devices 116. As usage data is collected from listening devices 116, selectable audio provider 100 tracks the number of listening devices that have selected each audio channel. After the period of time selected by the operator, selectable audio provider 100 can stop transmitting an unused audio channel, thereby reducing unnecessary traffic on network 104. The disabled audio track can be automatically enabled when one of listening devices 116 selects the track again.

In one embodiment, during periods of time without dialogue, selectable audio provider 100 transmits upcoming dialogue to be buffered within listening devices 116. Listening devices 116 utilize timing information transmitted by selectable audio provider 116 to synchronize the preloaded audio when the dialogue resumes. Such a configuration can be used to relieve network congestion between selectable audio provider 100 and listening devices 116. Selectable audio provider 100 can continue to provide audio that is preloaded in listening devices 116.

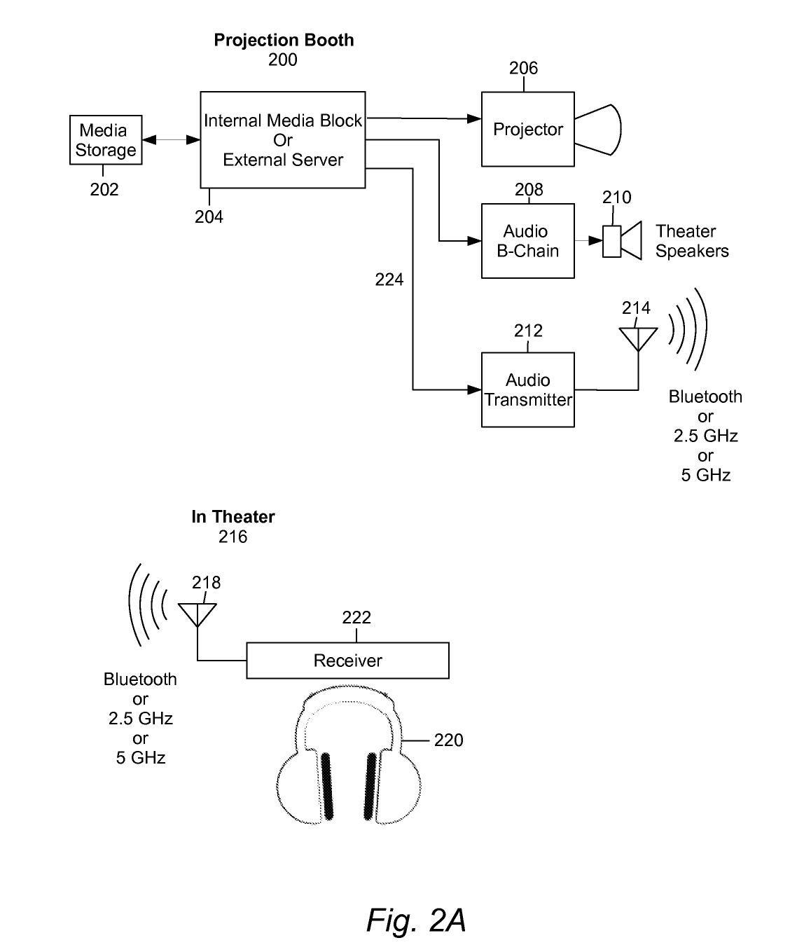

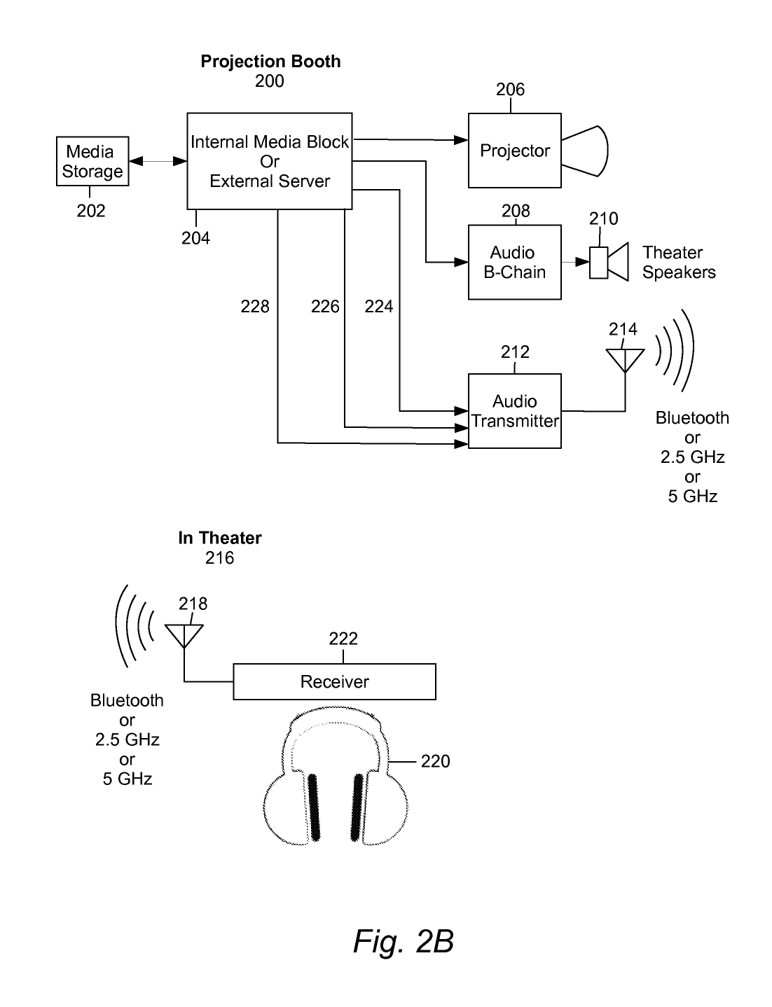

FIG. 2A depicts one embodiment of the present invention for use in a movie theater. The sound management of the movie theater is divided into an A Chain and a B Chain. The A Chain comprises media storage 202, internal media block (or external server) 204, and projector 206, all of which are located in projection booth 200. Media storage 202 stores the video and multiple audio sources for the film. In some embodiments, the film is delivered in a hard drive and loaded onto the media storage. The internal media block (or external server) 204 synchronizes the transmission of the video from media storage 202 to projector 206 and the transmission of the multiple audio tracks from media storage 202 through audio transmitter 212. In this embodiment, the B Chain comprises theater speakers 210, audio transmitter 212, and various power amplifiers (not shown) to provide sound in theater 216. Audio transmitter 212 transmits multiple dialogue tracks using either Bluetooth, 2.5 GHz or 5 GHz wireless transmission. A viewer in theater 216 wears headphones 220, which comprise headphone antenna 218 and receiver 222, and can receive the various dialog tracks via the Bluetooth, 2.5 GHz or 5 GHz signals. Headphones 220 allow the viewer to dynamically adjust the language and volume of the dialogue track. In addition, the viewer can block out the ambient noise and or dialogue track from the theater speakers.

FIG. 2B depicts a similar embodiment for use in a movie theater. Internal media block (or external server) 204 is coupled to audio transmitter 212 via communication lines 224, 226 and 228, which may, for example, comprise conventional Ethernet connections. Internal media block (or external server) 204 provides digital data to audio transmitter 212 containing the digital audio data for the music and effect audio track, separate audio data for each language track, and metadata for use by the transmitter. Audio transmitter 212 creates the audio tracks for transmission by mixing the music and effect audio track with each of the language tracks in real time. For example, audio transmitter 212 mixes data for a Spanish audio track with the music and effect audio track to produce a Spanish audio mix that is then transmitted for use by Spanish-speaking viewers. In this example, audio transmitter 212 also mixes data for an English audio track with the music and effect audio track to produce an English audio mix that is then transmitted for use by English-speaking viewers. In such an embodiment, audio transmitter 212 preferably supports a synchronous clock signal that enables audio transmitter 212 to maintain audio and video synchronization. In one embodiment, the digital audio data for the music and effect audio track is transmitted via communication line 224, the digital audio data for the language tracks is transmitted via communication line 226, and the synchronous clock signal is transmitted via communication line 228. It should be understood that additional or fewer communication lines may be utilized, and communication lines 224, 226 and 228 may be consolidated into a single communication line, as depicted in FIG. 2A.

As shown in FIG. 3A, listening device 300 is preferably a wireless headphone. Listening device 300 comprises left headphone 302A and right headphone 302B coupled to housing 310, which comprises adjustable band 306. Adjustable band 306 allows the user to adjust the position of left headphone 302A and right headphone 302B to rest comfortably and securely on the listener's head. Housing 310 is designed for the user to comfortably wear listening device 300 with left headphone 302A positioned over the user's left ear and right headphone 302B positioned over the user's right ear. Left headphone 302A and right headphone 302B comprise left headphone pad 304A and right headphone pad 304B, respectively. The headphone pads preferably comprise soft foam or other material(s) suitable for contact with a user's ears for extended periods of time. Further, the headphone pads can reduce the amount of external noise heard by the user. In the preferred embodiment, at least one top pad 308 is disposed on adjustable band 306. Top pad 308 provides a comfortable cushion between adjustable band 306 and the top of the user's head during extended use. Left headphone pad 304A, right headphone pad 304B, and top pad 308 can be covered by a plastic or any suitable material allowing for the pads to be easily cleaned.

In the preferred embodiment, the external housing of right headphone speaker 302B comprises various controls including volume control 312, noise cancellation control 322, power switch 314, and audio channel selector 316. These controls allow the user to customize the movie experience. Volume control 312 allows the user to select predetermined volume levels for the headphone speakers. Noise cancellation control 322 allows the user to select predetermined amplitude levels for a noise cancellation signal designed to cancel out external sound. A noise cancellation switch is included to enable and disable the noise cancellation feature. Power switch 314 allows the user to enable and disable listening device 300 from communicating with a selectable audio provider. In some embodiments, listening device 300 is automatically turned on by a wake up signal from the selectable audio provider that enables a wake-on system on chip in listening device 300. Indicators, such as LEDs, may optionally be included on the external housing to indicate the status of listening device 300. For example, a light indicator can display red to indicate no connection, amber for sub-optimal connection, and green for optimal connection. In one embodiment, an error message is transmitted to the selectable audio provider when listening device 300 is experiencing a problem. Listening device 300 can include additional controls, such as a volume limit switch that limits the maximum volume levels. In some embodiments, listening device 300 can include a “no sound” mode in which no audio is provided to left headphone 302A or right headphone 302B and noise cancellation is active, thereby minimizing the total amount of sound experienced by the user.

Listening device 300 further comprises a receiver and a transmitter, which are described in detail below with reference to FIG. 3B. The receiver is configured to receive a signal from the plurality of audio channels transmitted by transmitter 106 of selectable audio provider 100 shown in FIG. 1. In the preferred embodiment, the listener uses audio channel selector 316 to select an audio channel. The received signal is then reproduced as an audio output to left headphone speaker 302A and right headphone speaker 302B. Listening device 300 can receive both mono and stereo audio formats received from transmitter 106. In the preferred embodiment, listening device 300 is powered by a rechargeable battery (not shown). The rechargeable battery is charged through port 318, which can be a micro USB port or any other suitable port. Port 318 can also be used to transfer information to be stored in the internal memory of listening device 300.

Left headphone 306A also includes insert 320. Insert 320 is configured to receive a memory device, such as a SD card. In the preferred embodiment, data is stored on the memory device. Such data may include the length of time that listening device 300 has been in use, the titles of movies that have been played, the audio track for each movie that has been played, and other data. In some embodiments, the memory device contains audio data. Listening device 300 can include an audio decoder capable of decoding the audio data stored as a MP3, OGG, AAC, WMA, FLAC, or other audio type, to produce a signal suitable for left headphone 302A and right headphone speaker 302B.

In the preferred embodiment, selectable audio provider 100 syncs the audio output with the video displayed by digital movie projector 114 by including timing information with the audio channels transmitted by transmitter 106. The user selects any of the audio channels or a specific audio channel for the timing information. Listening device 300 can include a switch or a position on audio channel selector 316 that permits the user to dynamically select between listening to the audio on the memory device or any of the other audio channels transmitted by selectable audio provider 100. The ability to listen to custom audio tracks that are synced with the video allows users to customize their experience at the theater. For example, a user can insert an audio commentary track into insert 320. These commentary tracks can not only enhance, but also encourage repeat viewing of a movie, thereby increasing revenue for theaters. Parents with children that want to repeatedly watch the same movie can listen to other tracks or cancel out the sound completely.

FIG. 3B illustrates a circuit diagram 350 of right headphone 304B. Circuit 350 comprises receiver 352 and transmitter 354. Receiver 352 is configured to receive data representing various audio channels transmitted by server 110. A listener uses audio selector 356 to select the desired audio channel. The audio channel data received by receiver 352 is transmitted to audio reproduction circuit 358, which separates the audio signal and any timing data from the audio channel data. In some embodiments, the timing data is used to synchronize the audio data received from a memory card as described above. The timing data can also be used to record the period of time that a user of listening device 300 listens to a specific audio channel. The decoded audio data is sent to audio amplifier 360. Audio amplifier 360 can be adjusted using the volume control of listening device 300.

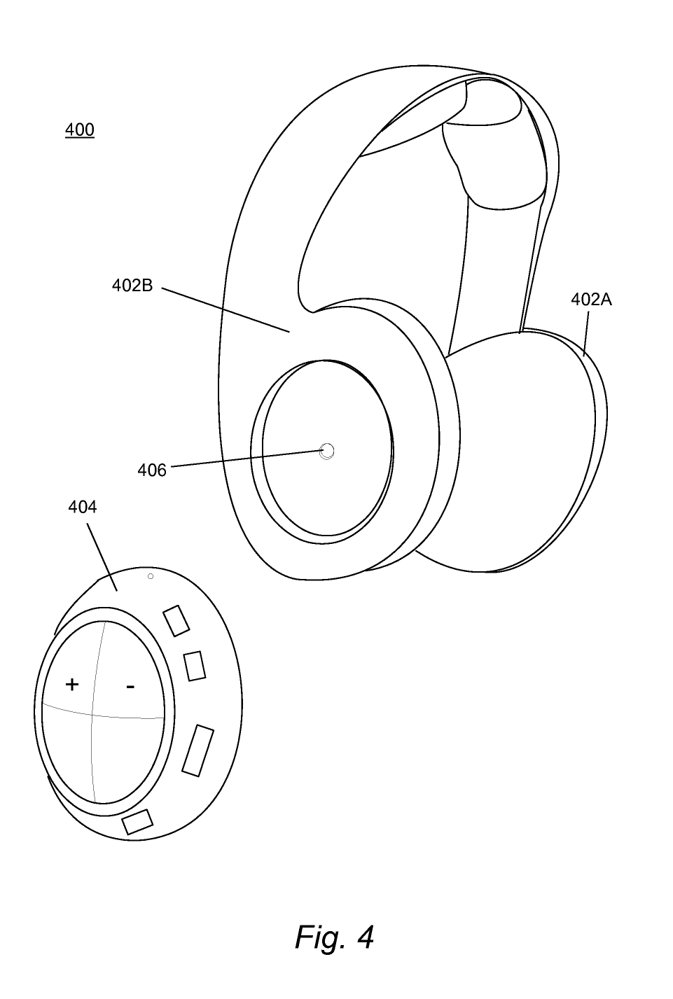

Although the headphones of the preferred embodiment are shown as an over-the ear-closed headphone, other headphone types known in the art, such as an open ear headphones or earbuds can be used. The various controls described above that allow the user to customize their movie going experience can also be incorporated in a separate device in communication with a user's headphones. In the embodiment depicted in FIG. 4, the controls are located on a removable control module 404 that can be attached to or removed from right headphone 402B. In this embodiment, the control module contains the circuitry described in detail with reference to FIG. 3B. The audio generated from the control module is transmitted to left headphone 402A and right headphone 402B through an audio jack 406 on right headphone 402B. Removable control module 404 allows for the quick repair of damaged headphones. Also, if a removable control module is damaged, a replacement removable control module can be easily connected to the headphone. Further, removable control module 404 allows for future upgrades to the noise cancellation, audio quality, and other features and functionality of listening device 400. Specifically, when a new removable control module is developed, it can be inserted into existing headphones, allowing old headphones to be re-used with new and improved technology.

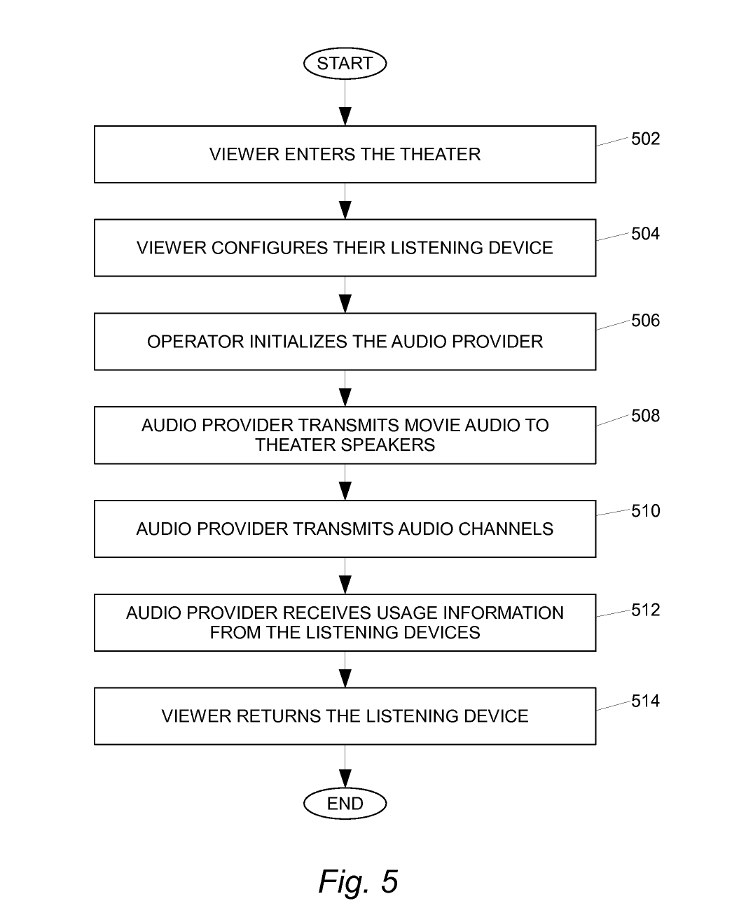

FIG. 5 depicts a flowchart representing a movie theater experience in accordance with the preferred embodiment. First, in step 502, viewers enter the movie theater and pick up a set of headphones. In the preferred embodiment, the headphones are wireless, enabling viewers to sit at any available seat.

Next, in step 504, viewers can adjust the settings on the headphone. To configure the dialogue track and volume level, a viewer can cycle through each available dialogue track using the channel selector on the headphone. Before the movie starts, the name of the language for a track is periodically played. This allows viewers to select the desired dialogue track and adjust the volume to a desired level. Viewers may select a new dialogue track or adjust the volume throughout the duration of the movie.

In step 506, an operator initializes the audio provider. An instructional video on the features of the headphones can be played at this time. In the preferred embodiment, the audio provider plays a corresponding instructional audio recording through the theater's sound system. The audio provider also wirelessly transmits one or more dialogue tracks that are synchronized with the instructional video. Viewers can adjust the dialogue track and volume level to comfortable settings. The audio provider also transmits one or more noise canceling channels and prompts viewers to calibrate their noise cancellation levels.

Next, in step 508, the movie begins, and the video is projected onto the movie screen. At this time, the audio provider transmits the movie audio (including the English dialogue track) to the theater's sound system, which typically comprises several speakers positioned throughout the theater. In step 510, the audio provider begins wirelessly transmitting four audio channels into the theater. In the preferred embodiment, channel 1 is an English dialogue-only track, channel 2 is a Spanish dialogue-only track, channel 3 is a noise cancellation track designed to cancel out all external audio being played through the theater's sound system, and channel 4 is a noise cancellation track designed to cancel out the English dialogue being played through the theater's sound system.

Viewers can choose whether to receive a dialogue-only track by enabling track 1 or track 2, and can adjust the volume of the dialogue-only track. In one example, Viewer A speaks English, but experiences hearing loss. Viewer A selects the English dialogue-only track on channel 1 and raises the volume of the track. As a result, Viewer A will hear the movie soundtrack through the theater's sound system, and will also hear the English dialogue at an increased volume through the headphones.

Viewers can also choose whether to apply a noise cancellation track, and can adjust the volume for the noise cancellation track. In another example, Viewer B only speaks Spanish. Viewer B selects the Spanish dialogue-only track on channel 2. To enhance the experience, Viewer B also selects the noise cancellation track for external English dialogue which is available on channel 4. In this configuration, Viewer B hears Spanish dialogue through the headphones and hears the soundtrack for the movie through the theater's speaker system. Because the noise cancellation on track 4 is enabled, Viewer B does not hear the English dialogue being played through the theater's speaker system. As a result, Viewer B hears Spanish dialogue with little to no interference from the English dialogue produced by the theater's sound system.

In yet another example, Viewer C speaks English and is sensitive to loud volumes. Viewer C does not select either dialogue-only track, but does select the noise cancellation track for all external audio on channel 3. Thereafter, the sound played through the movie theater speaker system will be attenuated for Viewer C. By adjusting the level of noise cancellation, Viewer C can adjust the volume of all audio to a comfortable level.

In another example, Viewer D only wants to hear English dialogue and does not want to hear any other sound effects or ambient sounds. Viewer D selects the English dialogue-only track on channel 1 and selects the noise cancellation track for all external audio of channel 3. In this configuration, Viewer D hears English dialogue through the headphones, and all sound produced by the theater's speaker system is attenuated. Each viewer in the theater can select among the channels and adjust the volumes repeatedly through the duration of the movie.

In the preferred embodiment, each viewer's headphones collect usage data. In step 512, the usage data reflects the audio level selected by the viewer, the channel(s) selected by the viewer, and the noise cancellation level selected by the viewer. This usage information is wirelessly transmitted back to the audio provider.

Next in step 514, viewers return the listening devices after the movie concludes. Thereafter, the headphones are cleaned and reused at the next movie show time. The usage information can be retrieved from the audio provider and stored and analyzed. Usage data may be used to enhance the experience of future viewers, to determine the actual demand for a specific language, or for other economic considerations. For example, dialogue tracks that are frequently selected can be assigned to convenient channels on the channel selector of the headphones. Dialogue tracks that are seldom used may be eliminated from future films.

In an alternative embodiment, only the non-dialogue sounds (such as the ambient sounds and sound effects) from the movie are played through the theater's sound system. Viewers wear open ear headphones that allow the non-dialogue sounds of the theater's sound system to pass through to them in addition to the dialogue track to which they are listening. In yet another embodiment, no audio is played through the theater's sound system. In this embodiment, viewers listen to all audio through the headphones, avoiding the need for noise cancellation.

Although English and Spanish are used in the foregoing description, various other languages can be used, and more than two language sources can be transmitted without departing from the spirit of the present disclosure.

While the preferred embodiment is disclosed in the context of a movie theater, the principles disclosed herein may be used in other environments as well. For example, a selectable audio provider may be adapted for in-home use. In such an embodiment, the selectable audio provider is connected to a television via cable or wireless means. Video and multiple audio channels may be loaded from physical media (such as a DVD) or via network communication (such as a streaming video service). It should be understood that the selectable audio provider may provide the video signal to the television, or the television may provide the audio channels to the selectable audio provider. It should also be understood that the selectable audio provider may be integrated within the television. As the video plays, the selectable audio provider transmits audio channels that are synced to the video displayed on the television. Viewers wear headphones capable of receiving signals from the selectable audio provider, and may dynamically select among the audio channels by operating their headphones as previously described. In such an embodiment, a family comprising native and non-native speakers can watch and enjoy an audiovisual program together in one room with one television, with everyone hearing their preferred language.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. The scope of the invention, therefore, shall be defined solely by the claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A system for delivering audiovisual content, comprising:
a video source configured to provide visual images;
a server configured to produce a plurality of audio signals synchronized to the visual images;
at least one speaker communicatively coupled to the server;
a transmitter communicatively coupled to the server and configured to transmit the plurality of audio signals;
at least one listening device comprising a headphone, a receiver, and a control module; and
wherein the listening device is configured to receive the plurality of audio signals and play one of the plurality of audio signals via the headphone.

2. The system of claim 1, wherein the control module comprises:
an audio channel selector; and
an audio amplification control.

3. The system of claim 2, wherein:
the transmitter is a wireless transmitter; and
the receiver is a wireless receiver.

4. The system of claim 3, wherein the plurality of audio signals comprise a plurality of language tracks.

5. The system of claim 3, wherein the listening device comprises a noise cancellation module.

6. The system of claim 5, wherein:
the server is configured to produce a noise cancellation signal;
the transmitter is configured to transmit the noise cancellation signal; and
the listening device is configured to receive and process the noise cancellation signal.

7. The system of claim 6, wherein the noise cancellation signal corresponds to a dialogue track.

8. The system of claim 6, wherein the listening device comprises a noise cancellation amplification control.

9. The system of claim 8, wherein the listening device comprises a usage monitor and a listening device transmitter.

10. A method of delivering audiovisual content, comprising:
projecting visual images;
producing a plurality of audio signals synchronized to the visual images;
playing a first one of the plurality of audio signals through a speaker;
transmitting two or more of the plurality of audio signals to a listening device; and
playing one of the two or more of the plurality of audio signals through the listening device.

11. The method of claim 10, comprising:
selecting between the two or more of the plurality of audio signals; and
modifying the volume of a selected audio signal.

12. The method of claim 11, comprising:
wirelessly transmitting the two or more of the plurality of audio signals.

13. The method of claim 12, wherein the plurality of audio signals comprise a plurality of language tracks.

14. The method of claim 12, comprising:
cancelling sound via the listening device.

15. The method of claim 14, wherein:
generating a noise cancellation signal;
transmitting the noise cancellation signal;
receiving the noise cancellation signal at the listening device; and
processing the noise cancellation signal at the listening device.

16. The method of claim 15, wherein the noise cancellation signal corresponds to a dialogue track.

17. The method of claim 15, comprising:
adjusting a level of the noise cancellation signal.

18. The method of claim 17, comprising:
monitoring a usage of the listening device; and
monitoring a selection of an audio signal.

19. A method of delivering audiovisual content, comprising:
projecting a video on a screen;
playing a first audio track via a speaker system;
wirelessly transmitting a second audio track;
wirelessly transmitting a third audio track;
receiving the second audio track at a plurality of listening devices;
receiving the third audio track at a plurality of listening devices;
at each of the plurality of listening devices, selectively playing the second audio track; and
at each of the plurality of listening devices, selectively playing the third audio track.

20. The method of claim 19, further comprising:
transmitting a noise cancellation signal;
receiving the noise cancellation signal at the plurality of listening devices;
at each of the plurality of listening devices, selectively integrating the noise cancellation signal.

21. A system for monitoring an audiovisual experience, comprising:
a visual image display;
a plurality of audio signals synchronized to the visual image display;
a usage monitor;
at least one listening device comprising a headphone, a receiver, a control module, and a transmitter; and
wherein the listening device is configured to transmit usage data via the transmitter to the usage monitor.

22. The system of claim 21, wherein the listening device is configured to transmit the usage data in real time.

23. The system of claim 21, wherein usage data comprises at least one of: a channel selection, a volume setting, and a noise cancellation setting.
